(19) United States
(12) Patent Application Publication
(10) Pub. No.: US 2025/0384675 A1
(43) Pub. Date: Dec. 18, 2025

(54) BUILDING INSIDE STRUCTURE RECOGNITION SYSTEM AND BUILDING INSIDE STRUCTURE RECOGNITION METHOD

(71) Applicants: TOPCON CORPORATION, Itabashi-ku, Tokyo (JP); RIKEN, Wako-shi, Saitama (JP)

(72) Inventors: Yasufumi FUKUMA, Wako (JP); Zaixing MAO, Wako (JP); Hisashi TSUKADA, Wako (JP); Toru ITO, Wako (JP); Satoshi WADA, Wako (JP); Satoshi YANOBE, Tokyo (JP)

(21) Appl. No.: 18/705,195

(22) PCT Filed: Sep. 5, 2022
(86) PCT No.: PCT/JP2022/033305

§ 371 Date: Mar. 27, 2025

(30) Foreign Application Priority Data
Oct. 28, 2021 (JP) 2021-176660

(51) Int. Cl. G06V 10/82; G06V 10/46; G06V 10/77

(52) U.S. Cl. CPC G06V 10/82; G06V 10/462; G06V 10/7715

(57) ABSTRACT

Provided is a building inside structure recognition system for recognizing a structure in a building by using a machine learning model. A building inside structure recognition system according to the present invention comprises: a machine learning model generation device that generates a machine learning model by executing machine learning in which a correct image generated from building information modeling (BIM) data is set as correct data and a virtually observed image generated by rendering the BIM data is set as observation data; and a building inside structure recognition device that recognizes a structure in a building by using the machine learning model generated by the machine learning model generation device.

### TECHNICAL FIELD

The present invention relates to a building inside structure recognition system and a building inside structure recognition method, and in particular to: a building inside structure recognition system that recognizes a structure disposed in the building of a construction such as a multi-story building by using deep learning based on a neural network; a machine learning model generation device that generates a machine learning model for recognizing a structure in a building; a building inside structure recognition device that recognizes a structure in a building by using a machine-learned model for recognizing a structure in a building; a building inside structure management system that manages a structure in a building that is recognized by using a machine-learned model for recognizing a structure in a building; and a building inside structure recognition method and program.

### BACKGROUND ART

Conventionally, as methods for checking the construction status of a construction such as a multi-story building under construction, a human checks the construction status at the construction site using a two-dimensional construction drawing or the like by making direct measurements using instruments or the like, or the construction status is compared with a building information modeling (BIM) model using remote sensing technology capable of measuring distance using reflected light, such as LiDAR (Light Detection and Ranging).

However, there has been a problem that when making measurements using LiDAR or the like, it is necessary to measure multiple portions of the construction site depending on the status of the site based on experience, and the accuracy of obtained data varies depending on the skill level of the measurer. Further, there has been a problem that it takes time and effort to register the obtained point cloud data and to manually identify structures in the building such as pipes and measure their positions and sizes. Additionally, there have been a problem with the accuracy of the captured point cloud data and data obtained by processing it, and a problem of difficulty in reusing data.

It is realistically difficult to choose to make measurements at all points of the construction site with an emphasis on data accuracy because the amount of information would be enormous. Although when the measurer is highly skilled, it is possible to measure only the necessary points based on his or her own experience, automation of measurement is required to prevent variations due to skill levels and to improve measurement efficiency.

When considering automating the determination of the regions of structures disposed at a construction site and the recognition of what those structures are in order to compare the construction status of the construction site in the middle of construction with its completed form, it is expected to use a learned model based on deep learning using a neural network.

In order to create a learned model for automating the recognition of structures in an image, a necessary and sufficient number of images of the construction site are required as input data for learning. Further, annotations for structures included in the image, that is, the result of recognition of the structures in the image indicating which part of the image is what are required as correct data for learning. However, it is difficult to collect a large number of photographic images of an actual construction site that can be used for learning as input data, and to annotate a huge number of structures for use as correct data.

Further, it is also conceivable to create a learned model by executing machine learning using rendered images obtained by rendering a completed three-dimensional model of the construction site so that it closely resembles the actual appearance, rather than photographs of the actual construction site. However, rendered images are mainly created for commercial purposes of a construction, and their production costs are high, so it is difficult to prepare rendered images as a necessary and sufficient number of learning images for learning. Further, the work of annotating structures included in rendered images also becomes enormous, and requires time and effort to be performed manually.

Therefore, there is a need to be able to prepare a necessary and sufficient number of learning images related to a construction site for learning, and to automate the annotation of structures included in the learning images. Further, there is a need to be able to recognize structures with high accuracy by using the thus created learned model.

In Non Patent Literature 1, regarding the problem of a huge amount of point cloud data in as-built modeling in which a 3D model is created based on three-dimensional measurement of an existing large-scale facility, the following has been pointed out: “It should be noted that measuring devices used for as-built modeling of large-scale facilities have a measuring principle different from that of point cloud measuring devices for small parts. For point cloud measurement of small parts, triangulation is generally performed using a laser output device and a CCD camera, but this method makes the device larger as the size of the object increases. Further, when small parts are measured, the measured point cloud is often several million points at most, but in the case of a large-scale facility, modeling requires a large amount of point cloud”.

For example, Patent Literature 1 discloses a construction production system comprising: “a CPU that functions as: existing portion investigation means for converting electronic data of an existing portion of a construction acquired from an existing drawing into three-dimensional CAD data, and for storing the three-dimensional CAD data together with various job site investigation data including point cloud data acquired by a three-dimensional laser scanner and a three-dimensional polygon model created from the point cloud data; construction member design means for disposing a member object to be newly constructed, which is selected from among member objects stored in advance in a member library, on the three-dimensional polygon model; and member construction position output means for searching for and outputting the member object corresponding to an ID unique to the member object obtained by reading an electronic tag attached to a member precut in a member factory with an ID reader together with construction position information thereof from the three-dimensional CAD model designed by the construction member design means according to the member object disposed by the construction member design means; and an automatic position pointing device for pointing a construction position of the member in the existing portion on the basis of construction position information of the member object output by the member construction position output means of the CPU”.

Further, Patent Literature 2 discloses “an image processing device comprising: an image acquisition unit that acquires an input image generated by imaging a real space using an imaging device; a recognition unit that recognizes a relative position and posture between the real space and the imaging device on the basis of one or more feature points imaged in the input image; an application unit that provides an augmented reality application using the recognized relative position and posture; and a display control unit that overlaps, on the input image, a guiding object that guides a user operating the imaging device in accordance with a distribution of the feature points so that recognition processing executed by the recognition part is stabilized”.

However, although Patent Literature 1 and Patent Literature 2 both disclose techniques for grasping a three-dimensional space or an object in a three-dimensional space, they do not particularly solve the problem of a huge amount of data such as three-dimensional point cloud data in large-scale facilities such as multi-story buildings and factories, and are not suitable for automating the recognition of structures in an image in order to quickly grasp the status of a construction site in the middle of construction.

### CITATION LIST

### Patent Literature

PATENT LITERATURE 1: JP-A-2013-149119

PATENT LITERATURE 2: JP-A-2013-225245

NON-PATENT LITERATURE 1: Hiroshi Masuda, “Digitalization techniques for large-scale environments and their problems”, Collection of Lecture Papers from Academic Lectures at Conference by the Japan Society for Precision Engineering (Collection of Materials from Symposium at Conference by the Japan Society for Precision Engineering), 2007, Autumn, p. 81-84, Sep. 3, 2007

### SUMMARY OF INVENTION

### Technical Problem

Therefore, the present invention solves the above problems and provides a building inside structure recognition system and a building inside structure recognition method that recognize a structure in a building by using a learned model obtained by using images from building information modeling (BIM) data or the like as training data.

Further, the present invention provides a machine learning model generation device that generates a machine learning model for recognizing a structure in a building.

Further, the present invention provides a building inside structure recognition device that recognizes a structure in a building by using a machine-learned model for recognizing a structure in a building.

Further, the present invention provides a building inside structure management system that manages a structure in a building recognized by using a machine-learned model for recognizing a structure in a building.

Further, the present invention provides a program for causing a computer to execute each step of the building inside structure recognition method.

### Solution to Problem

In order to solve the above problems, the present invention provides a machine learning model generation device that generates a machine learning model for recognizing a structure in a building, the machine learning model generation device comprising: a correct image generation unit that generates a correct image from building information modeling (BIM) data; a virtually observed image generation unit that generates a virtually observed image by rendering the BIM data; and a machine learning model generation unit that generates a machine learning model by executing machine learning in which the correct image generated by the correct image generation unit is set as correct data and the virtually observed image is set as observation data.

A machine learning model generation device according to an aspect of the present invention, further comprises a reinforcing image generation unit that generates a reinforcement image to be used as part of input data when generating the machine learning model.

In a machine learning model generation device according to an aspect of the present invention, the correct image is a mask image having a mask region indicating a structure, and the reinforcement image is a skeleton image obtained by extracting a feature line of the mask region of the correct image. The feature line is, for example, a center line, an edge, or the like.

A machine learning model generation device according to an aspect of the present invention, further comprises a virtually observed image processing unit that generates an enhanced virtually observed image by performing, on the virtually observed image generated by the virtually observed image generation unit, image processing for bringing the virtually observed image closer to a real image.

In a machine learning model generation device according to an aspect of the present invention, the image processing performed by the virtually observed image processing unit includes at least one or more of addition of a light source, addition of illumination light, or addition of a shadow.

In a machine learning model generation device according to an aspect of the present invention, the virtually observed image processing unit generates a texture-added image by adding texture of the structure to the enhanced virtually observed image.

In a machine learning model generation device according to an aspect of the present invention, the machine learning model generation unit generates the machine learning model by deep learning using a neural network.

Further, the present invention provides a building inside structure recognition device that recognizes a structure in a building by using a machine-learned model for recognizing a structure in a building, the building inside structure recognition device comprising a recognition unit that when an image of inside of a real building is input to the machine-learned model as input data, recognizes a structure in the image to output a recognition result image indicating a region of the structure in the image as output data, wherein the machine-learned model is generated by executing machine learning in which a correct image generated from building information modeling (BIM) data is set as correct data and a virtually observed image generated by rendering the BIM data is set as observation data.

In a building inside structure recognition device according to an aspect of the present invention, the recognition unit recognizes a structure in the image by further using a structure selection image indicating a region of the structure as input data in addition to the image of inside of the real building.

In a building inside structure recognition device according to an aspect of the present invention, the recognition unit removes text included in the image of inside of the real building, and recognizes a structure in the image by using the image after text removal as input data.

In a building inside structure recognition device according to an aspect of the present invention, the machine-learned model is generated by deep learning using a neural network.

Further, the present invention provides a building inside structure recognition system for recognizing a structure in a building by using a machine learning model, the building inside structure recognition system comprising: a machine learning model generation device that generates a machine learning model by executing machine learning in which a correct image generated from building information modeling (BIM) data is set as correct data and a virtually observed image generated by rendering the BIM data is set as observation data; and a building inside structure recognition device that recognizes a structure in a building by using the machine learning model generated by the machine learning model generation device.

Further, the present invention provides a building inside structure management system that manages a structure in a building recognized by using a machine-learned model for recognizing a structure in a building, the building inside structure management system comprising a database that stores data on the structure recognized in the above building inside structure recognition device or data on a member of the structure.

Further, the present invention provides a building inside structure recognition system for recognizing a structure in a building by using a machine learning model, the building inside structure recognition system comprising: the machine learning model generation device according to any of the above aspects of the present invention; and the building inside structure recognition device according to any of the above aspects of the present invention.

Further, the present invention provides a building inside structure recognition method, comprising: a step of generating a machine learning model by executing machine learning in which a correct image generated from building information modeling (BIM) data is set as correct data and a virtually observed image generated by rendering the BIM data is set as observation data; and a step of recognizing a structure in a building by using the machine learning model.

Further, the present invention provides a program that causes a computer to execute each step of the above building inside structure recognition method.

In the present invention, “building information modeling (BIM) data” refers to data of a three-dimensional model of a building reproduced on a computer.

In the present invention, a “real image” refers to an image such as a photograph obtained by photographing the real world with a camera.

### Advantageous Effects of Invention

The present invention exerts the effect that it is possible to focus on noteworthy members at a construction site to measure their shapes and positions, thereby improving the accuracy and speed.

Further, the number of members to be managed at a construction site can be reduced, and accordingly, the amount of data handled by a member management system for a construction site can be significantly reduced.

Other objects, features and advantages of the present invention will become apparent from the following description of embodiments of the present invention with reference to the accompanying drawings.

### BRIEF DESCRIPTION OF DRAWINGS

FIG. 1 is a schematic diagram showing the whole of a building inside structure recognition system according to the present invention.

FIG. 2 is a diagram showing an overview of a machine learning model generation device of the present invention.

FIG. 3 is a diagram showing a machine learning model generation device according to a first aspect of the present invention.

FIG. 4 is a diagram showing a machine learning model generation device according to a second aspect of the present invention.

FIG. 5 is a diagram showing a machine learning model generation device according to a third aspect of the present invention.

FIG. 6A is a schematic diagram showing an overview of a building inside structure recognition device according to the present invention.

FIG. 6B is a schematic diagram showing a building inside structure recognition device according to an aspect of the present invention.

FIG. 6C is a schematic diagram showing a building inside structure recognition device according to another aspect of the present invention.

FIG. 7A is a diagram showing processing by a verification unit according to an aspect of the present invention.

FIG. 7B is a diagram showing processing by a verification unit according to another aspect of the present invention.

FIG. 8 is a diagram showing an overview of a processing flow of the machine learning model generation device of the present invention.

FIG. 9 is a diagram showing a processing flow of the machine learning model generation device according to the first aspect of the present invention.

FIG. 10 is a diagram showing a processing flow of the machine learning model generation device according to the second aspect of the present invention.

FIG. 11 is a diagram showing a processing flow of the machine learning model generation device according to the third aspect of the present invention.

FIG. 12 is a diagram showing a processing flow of the building inside structure recognition device according to an aspect of the present invention.

FIG. 13 is a schematic diagram showing a processing flow of the building inside structure recognition device according to another aspect of the present invention.

FIG. 14 is a diagram showing an overview of the building inside structure management system of the present invention.

### DESCRIPTION OF EMBODIMENTS

### Embodiment 1

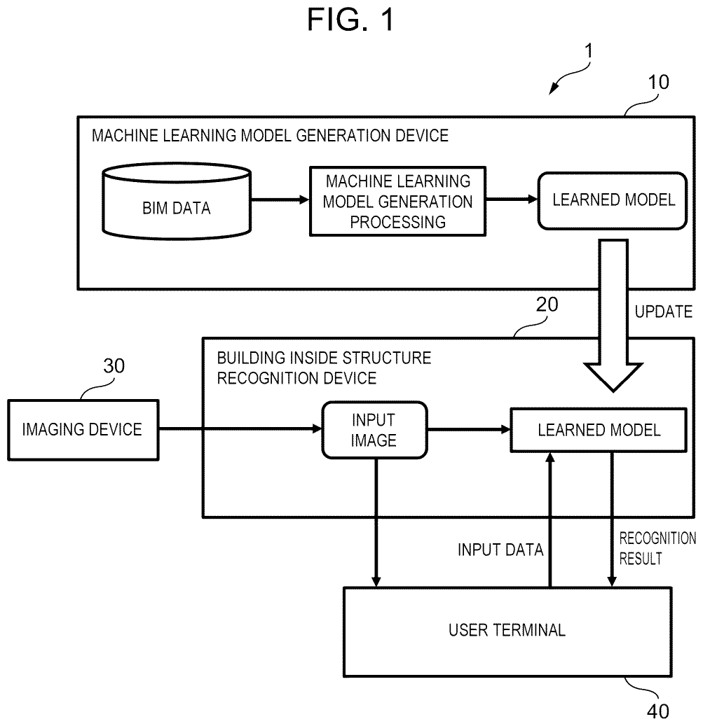

FIG. 1 is a schematic diagram showing the whole of a building inside structure recognition system 1 according to the present invention.

The building inside structure recognition system 1 according to the present invention comprises: a machine learning model generation device 10 that generates a machine learning model by executing machine learning in which a correct image generated from building information modeling (BIM) data is set as correct data and a virtually observed image generated by rendering the BIM data is set as observation data; and a building inside structure recognition device 20 that recognizes a structure in a building by using the machine learning model generated by the machine learning model generation device.

The building inside structure recognition system 1 is used to recognize a structure in a building by using a machine learning model. For example, in order to check the progress of the work at a construction site in the middle of construction, it is possible to photograph the construction site with a camera and recognize structures such as pipes, ducts, columns, and walls included in the photographed image. By grasping the status such as the positions and ranges of the recognized structures, a user can check whether the construction work is proceeding as planned according to the drawings or the like.

The building inside structure recognition system 1 may include an imaging device 30, or may use an external imaging device. The imaging device 30 may be any camera, for example, a still image camera, a video camera, a mobile camera mounted on a mobile terminal, a CCD camera, or the like. An input image to be recognized by the building inside structure recognition device 20 is an image to be recognized, for example, a real image such as a photograph of the site obtained by photographing a construction site in the middle of construction. When the building inside structure recognition system 1 includes the imaging device 30, the input image may be an image acquired from the imaging device 30. When the building inside structure recognition system 1 does not include the imaging device 30, the input image may be one captured by external imaging means and stored in advance in a database or the like.

The building inside structure recognition system 1 may include a user terminal 40, or may not include a user terminal, but may be such that the user terminal 40 and the building inside structure recognition system 1 are independent from each other. A recognition result recognized by the building inside structure recognition device 20 may be transmitted from the building inside structure recognition device 20 to the user terminal 40. Further, the building inside structure recognition device 20 may receive additional information to be used for recognition processing or verification processing from the user terminal 40, if necessary. For example, for use in verification processing, the building inside structure recognition device 20 may receive information from the user terminal 40 specifying the range of a structure in an image to be recognized.

The building inside structure recognition device 20 recognizes a structure in a building by using a machine-learned model generated by the machine learning model generation device 10, but when a new machine-learned model is generated by the machine learning model generation device 10, the building inside structure recognition system 1 may update the machine-learned model of the building inside structure recognition device 20 to the new machine-learned model.

The functions of the machine learning model generation device 10 may be built on a cloud service. Further, when the machine learning model generation device 10 and the building inside structure recognition device 20 are physically separated, they may exchange data and the like with each other over a network.

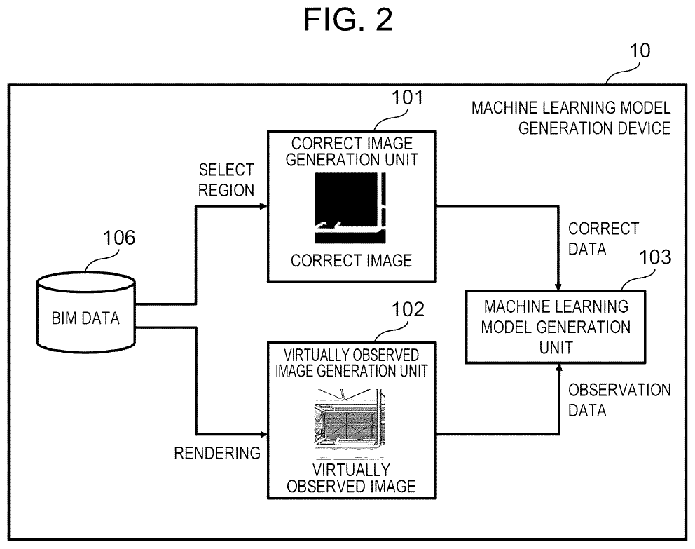

FIG. 2 is a diagram showing an overview of the machine learning model generation device 10 of the present invention.

The machine learning model generation device 10 generates a machine learning model for recognizing a structure in a building. The machine learning model generation device 10 comprises: a correct image generation unit 101 that generates a correct image from building information modeling (BIM) data; a virtually observed image generation unit 102 that generates a virtually observed image by rendering the BIM data; and a machine learning model generation unit 103 that generates a machine learning model by executing machine learning in which the correct image generated by the correct image generation unit is set as correct data and the virtually observed image is set as observation data.

The correct image generation unit 101 generates a correct image from building information modeling (BIM) data. The correct image is used as correct data when the machine learning model generation unit 103 generates a machine learning model. The correct image may be a mask image having a mask region indicating a structure. The correct image may be, for example, a binarized image generated from the BIM data, as shown in FIG. 2. In the example of FIG. 2, the region of a pipe, which is a structure in a building, is expressed in white, and the other parts are expressed in black. The correct image is not limited to the example of FIG. 2, but may be an image in another form depending on the structure to be recognized.

Here, “BIM data” refers to data of a three-dimensional model of a building reproduced on a computer. The BIM data generally includes information on the three-dimensional structure of a building, and by viewing building materials as objects for each part, it can also include information other than the drawings such as the width, depth, height, material, assembly process, and time required for assembly for each part. By rendering the BIM data, its image in the three-dimensional space can be obtained. The rendered image can be expressed three-dimensionally to reproduce the appearance of the actual site, and a part thereof can also be extracted as a two-dimensional image. Image processing such as binarization, thinning, and skeletonization can be applied to the rendered image. In the example of FIG. 2, the BIM data is stored in a database 106 for storing the BIM data, but the database in which the BIM data is stored may be present outside the machine learning model generation device 10.

The virtually observed image generation unit 102 generates a virtually observed image by rendering the BIM data. Since it is difficult to collect a huge number of real images such as photographs of the site for machine learning, the present invention uses virtually observed images obtained by rendering already existing BIM data as observation data for machine learning in this way, instead of real images. A virtually observed image generated by rendering the BIM data is, for example, an image that looks like a reproduction of a real image as shown in FIG. 2.

The machine learning model generation unit 103 generates a machine learning model by executing machine learning in which the correct image generated by the correct image generation unit is set as correct data and the virtually observed image is set as observation data. In this way, by using correct images and virtually observed images generated from the BIM data instead of real images such as photographs of the site, it is possible to eliminate the problem of time and effort and difficulty in collecting a huge number of real images such as photographs of the site for machine learning.

The machine learning model generation unit 103 generates the machine learning model by deep learning using a neural network. Deep learning using a neural network requires a sufficient number of training data, but in the present invention, instead of collecting a huge number of real images such as photographs of the site and using them as training data, correct images and virtually observed images generated from the BIM data are used, so it is possible to solve the problem of time and effort and difficulty in collecting training data, and it is possible to obtain a necessary and sufficient number of training data for deep learning using a neural network.

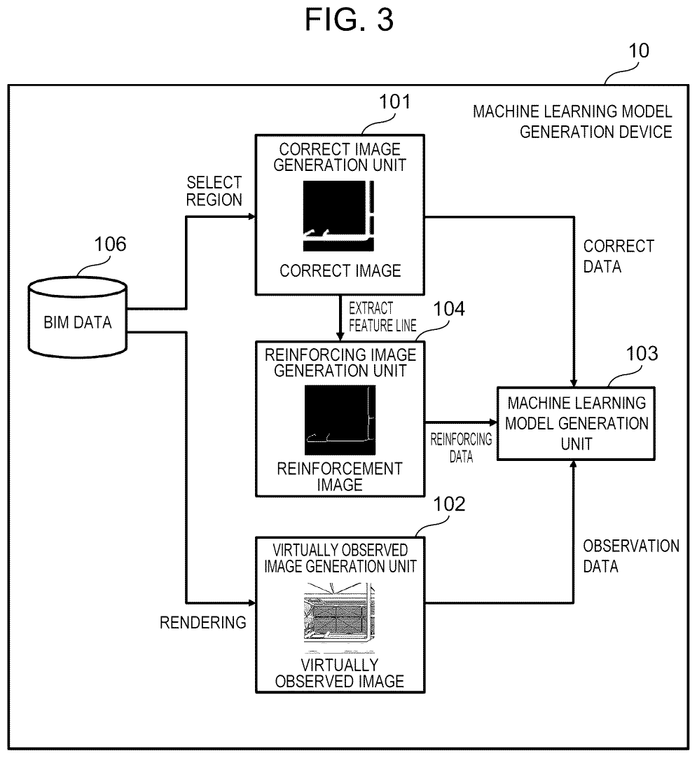

FIG. 3 is a diagram showing a machine learning model generation device 10 according to a first aspect of the present invention.

As shown in FIG. 3, in the first aspect of the present invention, the machine learning model generation device 10 may further comprise a reinforcing image generation unit 104 that generates a reinforcement image to be used as part of input data when generating the machine learning model. The parts other than the reinforcing image generation unit 104 are the same as those described in FIG. 2.

The reinforcing image generation unit 104 generates a reinforcement image to be used as part of input data when generating the machine learning model. The reinforcing image generation unit 104 generates a reinforcement image by extracting a feature line, such as a center line, from the correct image generated by the correct image generation unit 101. The reinforcement image is used as reinforcing data for improving the recognition accuracy of the model when the machine learning model generation unit 103 generates the machine learning model.

Similar to the example of FIG. 2, the correct image is a mask image having a mask region indicating a structure in the example of FIG. 3 as well. Further, the region of a pipe, which is a structure to be recognized, is shown in white and the other parts are shown in black in the example of FIG. 3 as well. The correct image is used as correct data when the machine learning model generation unit 103 generates the machine learning model.

In the example of FIG. 3, the reinforcement image is a skeleton image obtained by extracting a feature line of the mask region of the correct image. The feature line is, for example, a center line, an edge, or the like. In the example of FIG. 3, the reinforcement image is a skeleton image obtained by extracting the center line of the mask region of the correct image, but the reinforcement image may not be one obtained by extracting the center line of the mask region of the correct image, and other feature lines (e.g., edges) other than the center line may be extracted depending on the structure to be recognized. For example, an image obtained by extracting edges of a structure as feature lines may be used as the reinforcement image.

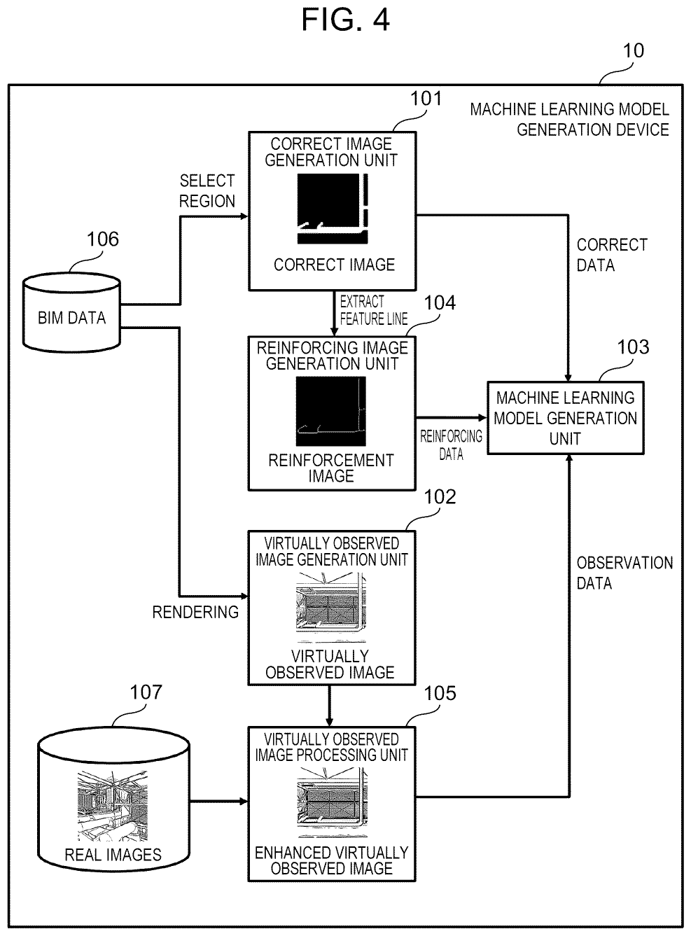

FIG. 4 is a diagram showing a machine learning model generation device according to a second aspect of the present invention.

As shown in FIG. 4, in the second aspect of the present invention, the machine learning model generation device 10 may further comprise a virtually observed image processing unit 105 that generates an enhanced virtually observed image by performing, on the virtually observed image generated by the virtually observed image generation unit 102, image processing for bringing it closer to a real image. The parts other than the virtually observed image processing unit 105 are the same as those described in FIG. 3.

The virtually observed image processing unit 105 generates an enhanced virtually observed image by performing, on the virtually observed image generated by the virtually observed image generation unit 102, image processing for bringing its appearance closer to that of a real image. The virtually observed image processing unit 105 may use data of real images stored in advance in the database 107 to perform image processing for bringing it closer to a real image. Here, the real image stored in the database 107 may not be one obtained by photographing the same portion as the virtually observed image. The real images stored in the database 107 are samples and, for example, in order to bring the color tone of a pipe in the virtually observed image closer to the color tone of a real pipe, data on the color tone of a pipe in a real image obtained by photographing another portion that is stored in the database 107 can be used as a reference. That is, information such as the color tone of the same structure as the structure in the virtually observed image is used. In the present invention, an image obtained by performing the image processing on a virtually observed image in this manner is referred to as an “enhanced virtually observed image”.

The image processing performed by the virtually observed image processing unit 105 includes at least one or more of filtering of spectral frequencies, addition of a light source, addition of illumination light, or addition of shadows. By filtering spectral frequencies, it is possible to bring the color tone closer to a real image. Further, by adding a light source, adding illumination light, or adding shadows, the way of being illuminated with light can be made closer to a real image. While a virtually observed image is used as observation data for machine learning instead of a real image as described above, an enhanced virtually observed image that has undergone the image processing so as to be closer to a real image can be used as observation data to further improve the recognition accuracy of the model when the machine learning model generation unit 103 generates the machine learning model.

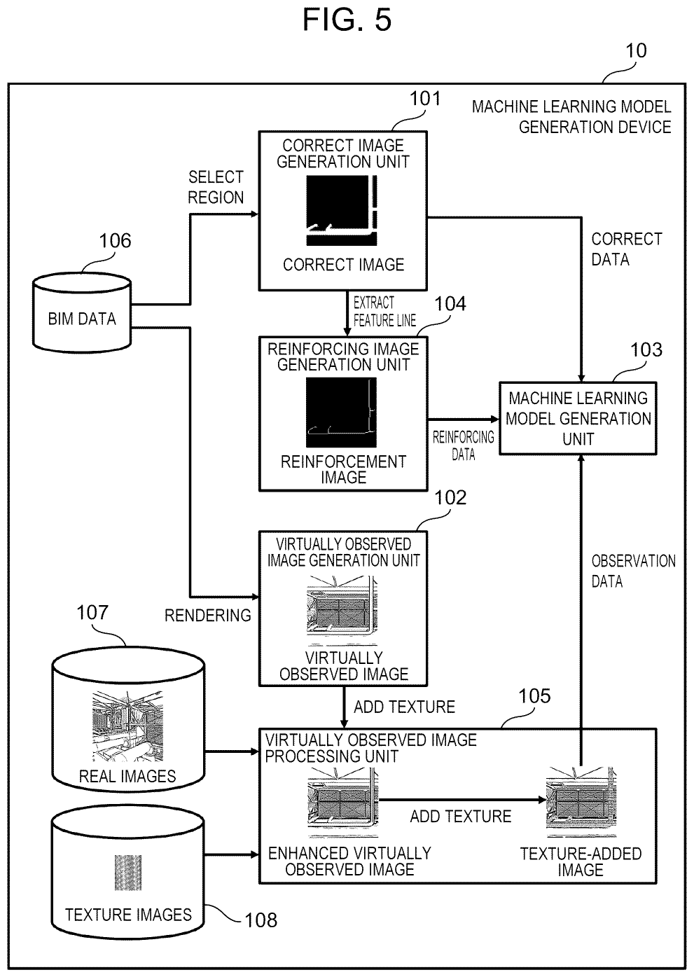

FIG. 5 is a diagram showing a machine learning model generation device according to a third aspect of the present invention.

As shown in FIG. 5, in the third aspect of the present invention, the virtually observed image processing unit 105 generates a texture-added image by adding texture of the structure to the enhanced virtually observed image. The parts other than the addition of texture are the same as those described in FIG. 4.

The virtually observed image processing unit 105 uses data of a texture image stored in advance in the database 108 to add texture to the enhanced virtually observed image in order to bring it even closer to a real image. In the present invention, “texture” refers to a pattern or design on the surface of a structure. Here, the texture image stored in the database 108 may not be one obtained by photographing the same portion as the virtually observed image or the enhanced virtually observed image. The texture images stored in the database 108 are samples and, for example, in order to bring the texture of a pipe in the virtually observed image closer to the texture of a real pipe, data on the texture of a pipe in a real image obtained by photographing another portion that is stored in the database 108 can be used as a reference. That is, information on the texture of the same structure as the structure in the virtually observed image is used.

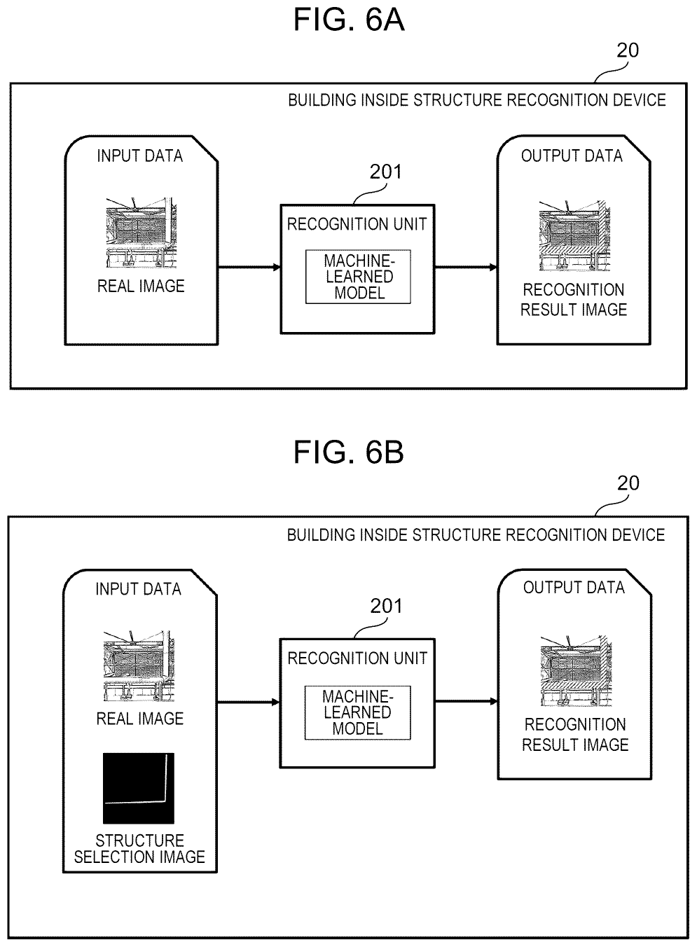

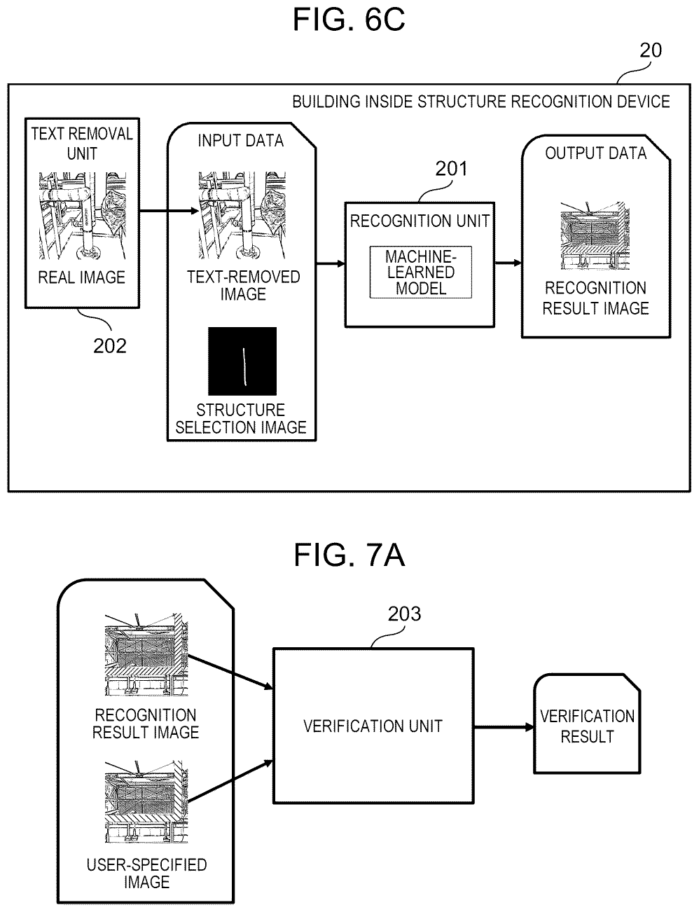

Next, the building inside structure recognition device 20 according to the present invention will be described using FIGS. 6A to 6C.

FIG. 6A is a schematic diagram showing an overview of the building inside structure recognition device 20 according to the present invention. The building inside structure recognition device 20 recognizes a structure in a building by using a machine-learned model for recognizing a structure in a building. The building inside structure recognition device 20 comprises a recognition unit 201 that when an image of inside of a real building is input to the machine-learned model as input data, recognizes a structure in the image to output a recognition result image indicating a region of the structure in the image as output data.

The recognition unit 201 has the machine-learned model, and when an image of inside of a real building is input to the machine-learned model as input data, recognizes a structure in the image to output a recognition result image indicating a region of the structure in the image as output data. In the example of FIG. 6A, the real image input as input data includes a pipe as a structure in the building. In the example of FIG. 6A, the pipe is recognized by the recognition unit 201, and the part of the pipe is colored or marked in the recognition result image as output data. That is, the colored or marked part in the recognition result image is a part recognized as a pipe, and that part of the image is annotated as a pipe. Although the example of FIG. 6A has given a description of a pipe, the present invention is not limited thereto, and structures other than pipes included in a real image may be similarly recognized.

The machine-learned model is generated by executing machine learning in which the correct image generated from building information modeling (BIM) data is set as correct data and the virtually observed image generated by rendering the BIM data is set as observation data. The machine-learned model generated by the machine learning model generation device 10 of any aspect of the present invention described before using FIGS. 2 to 5 can be used as the machine-learned model.

The machine-learned model is generated by deep learning using a neural network.

FIG. 6B is a schematic diagram showing a building inside structure recognition device according to an aspect of the present invention.

In the aspect of FIG. 6B, the recognition unit 201 recognizes a structure in the image by further using a structure selection image indicating a region of the structure as input data in addition to the image of inside of the real building. The other parts are the same as those described in FIG. 6A.

The structure selection image is an image indicating the region of the structure, and in the example of FIG. 6B, the structure selection image is a mask image in which the region of the pipe, which is the structure, is shown in white and the other parts are shown in black. The structure selection image may not be a mask image as shown in FIG. 6B, but be an image indicating the structure in another form depending on the structure to be recognized. Further, the structure selection image may be one obtained by a user selecting the structure, or the structure selection image may be one transmitted from the user terminal 40. By further using the structure selection image indicating the region of the structure as input data in addition to the image of inside of the real building, the accuracy of recognition in the recognition unit 201 can be improved. In particular, since the machine learning model generated in the machine learning model generation device 10 according to the first to third aspects of the present invention described using FIGS. 3 to 5 uses a reinforcement image as reinforcing data, the accuracy of recognition can be further improved when the recognition unit 201 performs recognition by using the machine learning models according to the first to third aspects.

FIG. 6C is a schematic diagram showing a building inside structure recognition device according to another aspect of the present invention.

In the example of FIG. 6C, the recognition unit 201 removes text included in the image of inside of the real building, and recognizes a structure in the image by using the image after text removal as input data. In the example of FIG. 6C, the text (characters) written on the pipe is removed by a text removal unit 202, and a text-removed image is used as input data. Further, in addition to the text-removed image, a structure selection image similar to that described in FIG. 6B may also be used as input data.

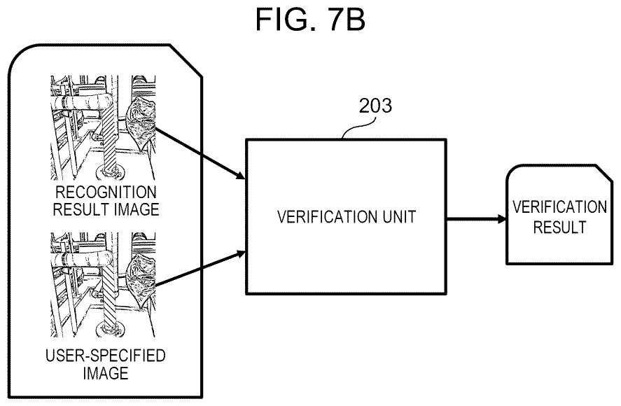

FIG. 7A is a diagram showing processing by a verification unit 203 according to an aspect of the present invention.

The verification unit 203 verifies the machine-learned model. The verification unit 203 verifies the machine-learned model by comparing an authentication result image with the user-specified image. In FIG. 7A, as an example, a recognition result image as a result of performing recognition of a pipe disposed in a building under construction, is compared with a user-specified image, which is an image obtained by the user specifying the region of the pipe in a real image at the same position in the building under construction.

FIG. 7B is a diagram showing processing by the verification unit 203 according to another aspect of the present invention.

In the example of FIG. 7B, a recognition result image as a result of performing recognition on a pipe containing text is compared with a user-specified image, which is an image obtained by the user specifying the region of the pipe in a real image at the same position in the building under construction.

Next, a building inside structure recognition method according to the present invention will be described.

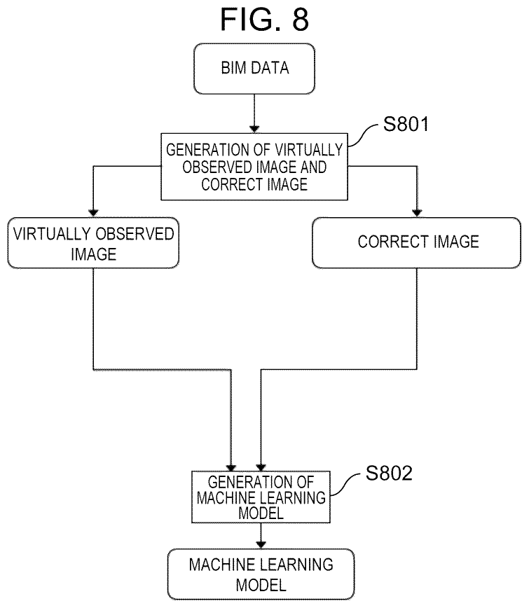

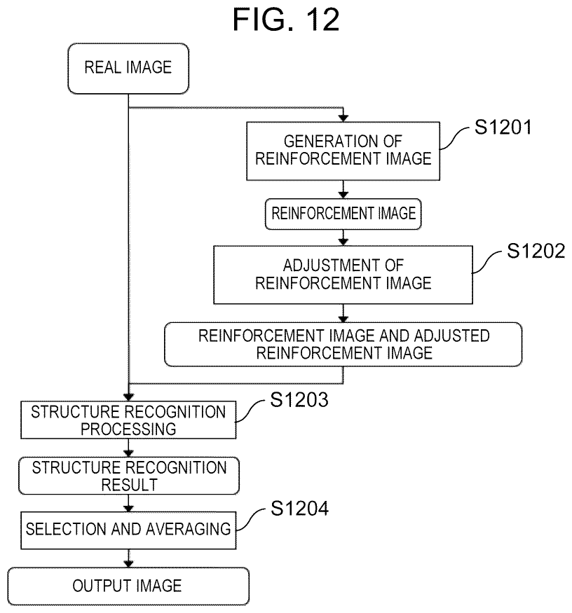

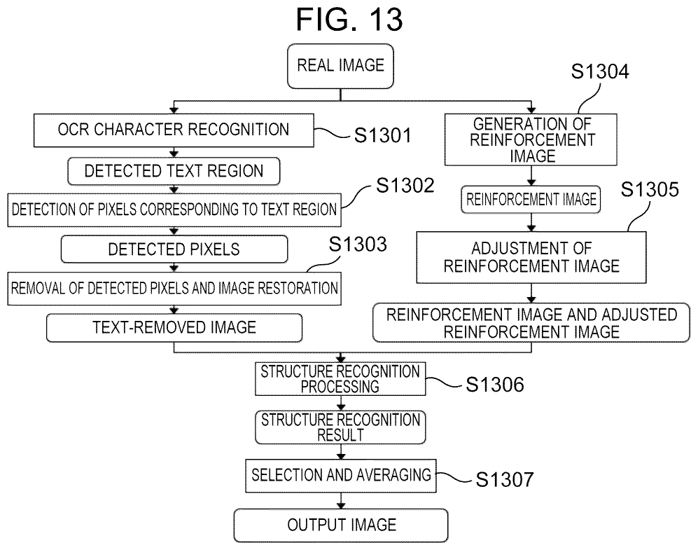

The building inside structure recognition method according to the present invention comprises: a step of generating a machine learning model by executing machine learning in which a correct image generated from building information modeling (BIM) data is set as correct data and a virtually observed image generated by rendering the BIM data is set as observation data (specifically, the steps for generating a machine learning model in FIGS. 8 to 11); and a step of recognizing a structure in a building by using the machine learning model (specifically, the steps for recognizing a structure in FIGS. 12 to 13).

Each step of the building inside structure recognition method can be performed by the building inside structure recognition system 1. Further, the step of generating a machine learning model in the building inside structure recognition method can be performed by the machine learning model generation device 10. Further, the step of recognizing a structure in a building in the building inside structure recognition method can be performed by the building inside structure recognition device 20. Each step described below can be performed by the building inside structure recognition system 1, the machine learning model generation device 10, the building inside structure recognition device 20, or each of the units described above, depending on the processing content.

FIG. 8 is a diagram showing an overview of a processing flow of the machine learning model generation device 10 of the present invention.

First, in step S801, a virtually observed image and a correct image are generated from BIM data. The virtually observed image is a rendering of the BIM data, and the correct image is a mask image having a mask region indicating a structure that is generated based on the BIM data. Next, a machine learning model is generated using the virtually observed image generated in step S801 as observation data and using the correct image as correct data (step S802).

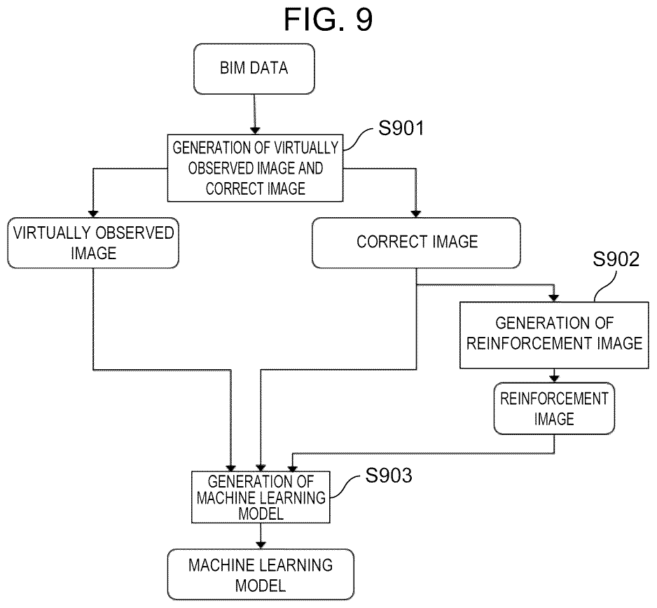

FIG. 9 is a diagram showing a processing flow of the machine learning model generation device 10 according to the first aspect of the present invention.

In the first aspect of the present invention, a virtually observed image and a correct image are first generated from BIM data in step S901, similar to step S801 in FIG. 8. The difference from the case in FIG. 8 is the addition of a step (step S902) of generating a reinforcement image by extracting a feature line from the correct image generated in step S901 of generating a virtually observed image and a correct image from BIM data. In the first aspect, a machine learning model is generated using the virtually observed image generated in step S901 as observation data and using the reinforcement image generated in step S902 as correct data (step S903).

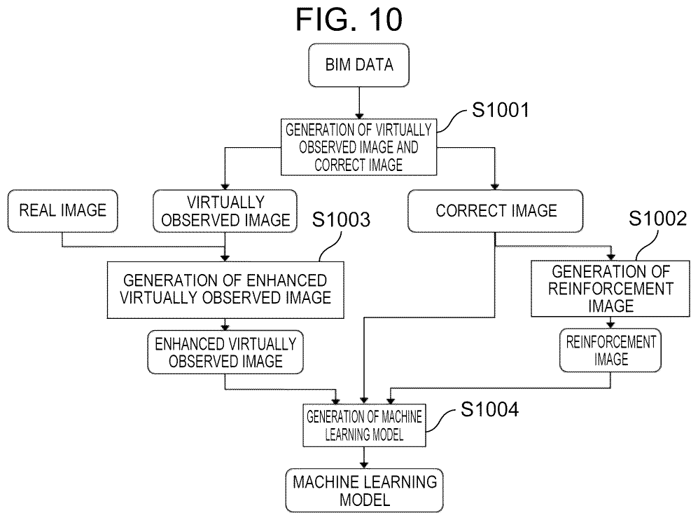

FIG. 10 is a diagram showing a processing flow of the machine learning model generation device 10 according to the second aspect of the present invention.

In the second aspect of the present invention, a virtually observed image and a correct image are first generated from BIM data in step S1001, similar to step 901 in FIG. 9. Further, similar to step S902 in FIG. 9, a reinforcement image is generated by extracting a feature line from the correct image generated in step S1001 of generating a virtually observed image and a correct image from BIM data (step S1002). The difference from the case in FIG. 9 is the addition of a step (step S1003) of generating an enhanced virtually observed image by performing image processing on the virtually observed image generated in step S1001. In step S1003, image processing is performed on the virtually observed image based on information on the real image such that it becomes closer to the real image. For example, at least one or more of filtering of spectral frequencies, addition of a light source, addition of illumination light, or addition of shadows may be performed as the image processing. In the second aspect, a machine learning model is generated using the enhanced virtually observed image generated in step S1003 as observation data and using the reinforcement image generated in step S1002 as correct data (step S1004).

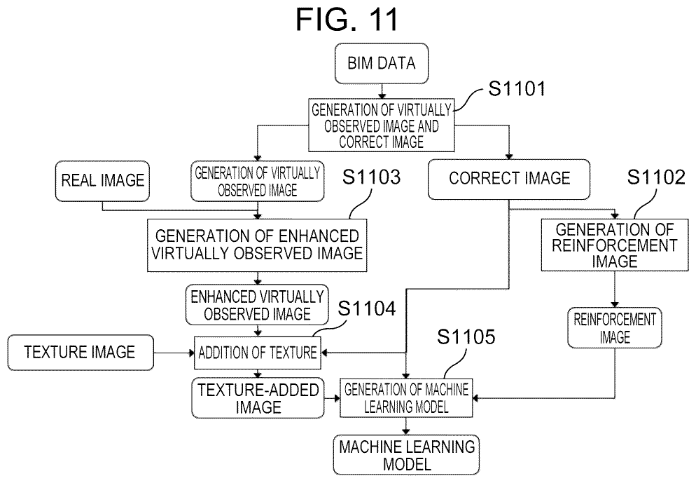

FIG. 11 is a diagram showing a processing flow of the machine learning model generation device 10 according to the third aspect of the present invention.

In the third aspect of the present invention, a virtually observed image and a correct image are first generated from BIM data in step S1101, similar to step S1001 in FIG. 10. Further, similar to step S1002 in FIG. 10, a reinforcement image is generated by extracting a feature line from the correct image generated in step S1101 of generating a virtually observed image and a correct image from BIM data (step S1102). Additionally, similar to step S1003 in FIG. 10, an enhanced virtually observed image is generated by performing image processing on the virtually observed image generated in step S1101 (step S1103). The difference from the case in FIG. 10 is the addition of a step (S1104) of adding a texture image to the enhanced virtually observed image generated in step S1103. In the third aspect, a machine learning model is generated using the texture-added image generated in step S1104 as observation data and using the reinforcement image generated in step S1102 as correct data (step S1105).

FIG. 12 is a diagram showing a processing flow of the building inside structure recognition device 20 according to an aspect of the present invention.

First, in step S1201, a reinforcement image is generated from a real image such as a photograph of a site. Next, reinforcement image adjustment is performed on the generated reinforcement image in step S1202. For example, when the structure to be recognized is a pipe, reinforcement image adjustment is a process of readjusting the length, inclination, or the like of the detection result of a feature line (e.g., a center line or an edge) of the pipe, as necessary. Next, structure recognition processing for recognizing a structure in a building is performed using a machine-learned model, with the real image, the reinforcement image generated in step S1201, and the reinforcement image adjusted in step S1202 as input data (step S1203). While the structure recognition result obtained in step S1203 may be used as output data as it is, selection and averaging may further be performed on the structure recognition result in step S1204. Selection and averaging are a process in which, for example, if the structure to be recognized is a pipe, when a pipe is imaged, a position where a pipe is detected is shifted vertically and horizontally and these positions are averaged, thereby performing imaging.

FIG. 13 is a schematic diagram showing a processing flow of the building inside structure recognition device 20 according to another aspect of the present invention.

The example of FIG. 13 is a process when text is written on a structure in a building. If text is written on a structure in a building, the text is removed prior to structure recognition processing. First, in step S1301, character recognition using OCR is performed on a real image such as a photograph of a site, and a text region in the image is detected. Next, pixels corresponding to the text region detected in step S1301 are detected (step S1302). Then, the pixels detected in step S1302 are removed and image restoration is performed (step S1303). Here, image restoration refers to, for example, reproducing the part of the structure hidden behind the text by filling the removed pixels with the colors or texture surrounding the pixels. This results in a text-removed image.

Further, similar to step S1201 in FIG. 12, a reinforcement image is generated from a real image such as a photograph of a site (step S1304). Additionally, similar to step S1201 in FIG. 12, the reinforcement image is adjusted (step S1305). Next, structure recognition processing for recognizing a structure in a building is performed using a machine-learned model, with the text-removed image obtained in step S1303, the reinforcement image generated in step S1304, and the reinforcement image adjusted in step S1305 as input data (step S1306). While the structure recognition result obtained in step S1306 may be used as output data as it is, selection and averaging may further be performed on the structure recognition result in step S1307.

Further, the present invention provides a program that causes a computer to execute each step of the building inside structure recognition method according to the present invention. The program may be recorded on a computer-readable recording medium. Additionally, the program may be stored in a server, run on the server, and/or provide its functions over a network.

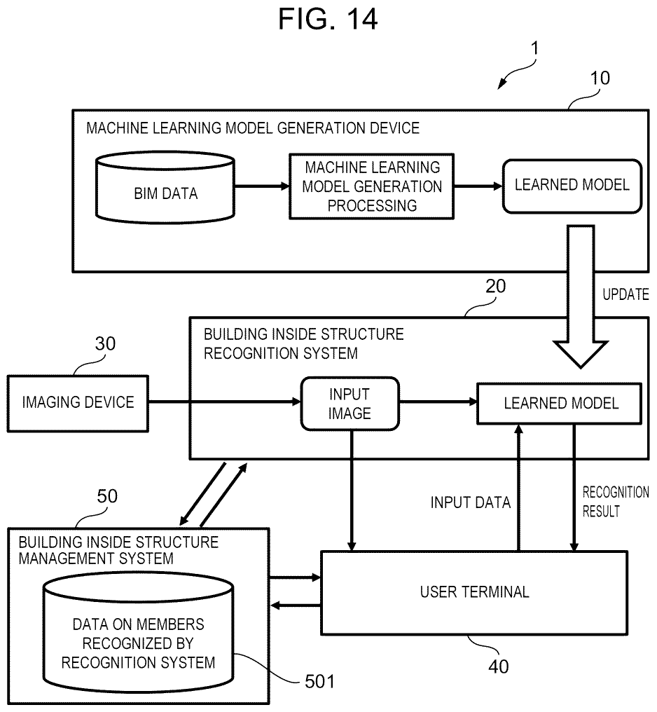

FIG. 14 is a diagram showing an overview of a building inside structure management system 50 of the present invention.

The building inside structure management system 50 manages a structure in a building recognized by using a machine-learned model for recognizing a structure in a building. The building inside structure management system 50 comprises a database 501 that stores data on the structure recognized in the building inside structure recognition device 20 or data on a member of the structure. The data on the structure or the data on the member of the structure stored in the database 501 may be transmitted to the user terminal 40. According to the building inside structure management system 50, it is possible to reduce the increase in the amount of data and the cost of management by storing and managing only data on noteworthy members and other necessary data such as the data on the structure in the building or the data on the member of the structure recognized by the building inside structure recognition device 20, and it is possible to improve the speed of measurement and processing by using only these necessary data.

Each aspect (e.g., the first to third aspects) of the machine learning model generation device 10 of the present invention described in the above embodiments and each aspect of the building inside structure recognition device 20 of the present invention can be implemented in any combination. Further, it is possible to implement the building inside structure recognition system 1 including any combination of these aspects. Further, the building inside structure management system 50 can be implemented in combination with any combination of these aspects.

According to the building inside structure recognition system and the building inside structure recognition method according to the present invention described above, it is possible to focus on noteworthy members at a construction site to measure their shapes and positions, thereby improving the accuracy and speed. Further, the number of members to be managed at a construction site can be reduced, and accordingly, the amount of data handled by a member management system for a construction site can be significantly reduced.

Although the above description has been made regarding the embodiments, it will be apparent to those skilled in the art that the present invention is not limited thereto, and that various changes and modifications can be made within the scope of the principles of the present invention and the appended claims.

### REFERENCE SIGNS LIST

1 Building inside structure recognition system
10 Machine learning model generation device
20 Building inside structure recognition device
30 Imaging device
40 User terminal
50 Building inside structure management system
101 Correct image generation unit
102 Virtually observed image generation unit
103 Machine learning model generation unit
104 Reinforcing image generation unit
105 Virtually observed image processing unit
201 Recognition unit
202 Text removal unit
203 Verification unit
501 Database

1. A machine learning model generation device that generates a machine learning model for recognizing a structure in a building, the machine learning model generation device comprising:
a correct image generation unit that generates a correct image from building information modeling (BIM) data;
a virtually observed image generation unit that generates a virtually observed image by rendering the BIM data;
a machine learning model generation unit that generates a machine learning model by executing machine learning in which the correct image generated by the correct image generation unit is set as correct data and the virtually observed image is set as observation data; and
a reinforcing image generation unit that generates a reinforcement image to be used as part of input data when generating the machine learning model,
wherein the correct image is a mask image having a mask region indicating a structure, and the reinforcement image is an image obtained by extracting a center line of the mask region of the correct image.

2. (canceled)

3. (canceled)

4. The machine learning model generation device according to claim 1, further comprising a virtually observed image processing unit that generates an enhanced virtually observed image by performing, on the virtually observed image generated by the virtually observed image generation unit, image processing for bringing the virtually observed image closer to a real image.

5. The machine learning model generation device according to claim 4, wherein the image processing performed by the virtually observed image processing unit includes at least one or more of filtering of a spectral frequency, addition of a light source, addition of illumination light, or addition of a shadow.

6. The machine learning model generation device according to claim 4, wherein the virtually observed image processing unit generates a texture-added image by adding texture of the structure to the enhanced virtually observed image.

7. The machine learning model generation device according to claim 1, wherein the machine learning model generation unit generates the machine learning model by deep learning using a neural network.

8. A building inside structure recognition device that recognizes a structure in a building by using a machine-learned model for recognizing a structure in a building, the building inside structure recognition device comprising
a recognition unit that when an image of inside of a real building is input to the machine-learned model as input data, recognizes a structure in the image to output a recognition result image indicating a region of the structure in the image as output data,
wherein the machine-learned model is generated by executing machine learning in which a correct image generated from building information modeling (BIM) data is set as correct data and a virtually observed image generated by rendering the BIM data is set as observation data, and
wherein a reinforcement image is used as part of input data when generating the machine learning model, and the correct image is a mask image having a mask region indicating a structure, and the reinforcement image is an image obtained by extracting a center line of the mask region of the correct image.

9. The building inside structure recognition device according to claim 8, wherein the recognition unit recognizes a structure in the image by further using a structure selection image indicating a region of the structure as input data in addition to the image of inside of the real building.

10. The building inside structure recognition device according to claim 8, wherein the recognition unit removes text included in the image of inside of the real building, and recognizes a structure in the image by using the image after text removal as input data.

11. The building inside structure recognition device according to of claim 8, wherein the machine-learned model is generated by deep learning using a neural network.

12. A building inside structure recognition system for recognizing a structure in a building by using a machine learning model, the building inside structure recognition system comprising:
a machine learning model generation device that generates a machine learning model by executing machine learning in which a correct image generated from building information modeling (BIM) data is set as correct data and a virtually observed image generated by rendering the BIM data is set as observation data; and
a building inside structure recognition device that recognizes a structure in a building by using the machine learning model generated by the machine learning model generation device, and
wherein a reinforcement image is used as part of input data when generating the machine learning model, and the correct image is a mask image having a mask region indicating a structure, and the reinforcement image is an image obtained by extracting a center line of the mask region of the correct image.

13. A building inside structure management system that manages a structure in a building recognized by using a machine-learned model for recognizing a structure in a building, the building inside structure management system comprising
a database that stores data on the structure recognized in the building inside structure recognition device according to claim 8 or data on a member of the structure.

14. A building inside structure recognition system for recognizing a structure in a building by using a machine learning model, the building inside structure recognition system comprising:
the machine learning model generation device according to claim 1; and
the building inside structure recognition device according to claim 8.

15. A building inside structure recognition method, comprising:
a step of generating a machine learning model by executing machine learning in which a correct image generated from building information modeling (BIM) data is set as correct data and a virtually observed image generated by rendering the BIM data is set as observation data; and
a step of recognizing a structure in a building by using the machine learning model, and
wherein a reinforcement image is used as part of input data when generating the machine learning model, and the correct image is a mask image having a mask region indicating a structure, and the reinforcement image is an image obtained by extracting a center line of the mask region of the correct image.

16. A program that causes a computer to execute each step of the method according to claim 15.
